(19) United States
(12) Patent Application Publication
(10) Pub. No.: US 2019/0043482 A1
(43) Pub. Date: Feb. 7, 2019

(54) FAR FIELD SPEECH ACOUSTIC MODEL TRAINING METHOD AND SYSTEM

(71) Applicant: BAIDU ONLINE NETWORK TECHNOLOGY (BEIJING) CO., LTD., Haidian District Beijing (CN)

(72) Inventors: Chao LI, Haidian District Beijing (CN); Jianwei SUN, Haidian District Beijing (CN); Xiangang LI, Haidian District Beijing (CN)

(73) Assignee: BAIDU ONLINE NETWORK TECHNOLOGY (BEIJING) CO., LTD., Haidian District Beijing (CN)

(21) Appl. No.: 16/051,672

(22) Filed: Aug. 1, 2018

(30) Foreign Application Priority Data
Aug. 1, 2017 (CN) 2017106480472

(51) Int. Cl. G10L 15/06; G10L 15/02; G10L 21/0208; G10L 15/16; G06N 3/08

(52) U.S. Cl. CPC G10L 15/063; G10L 15/02; G06N 3/08; G10L 15/16; G10L 21/0208

(57) ABSTRACT

The present disclosure provides a far field speech acoustic model training method and system. The method comprises: blending near field speech training data with far field speech training data to generate blended speech training data, wherein the far field speech training data is obtained by performing data augmentation processing for the near field speech training data; using the blended speech training data to train a deep neural network to generate a far field recognition acoustic model. The present disclosure can avoid the problem of spending a lot of time costs and economic costs in recording the far field speech data in the prior art; and reduce time and economic costs of obtaining the far field speech data, and improve the far field speech recognition effect.

The present application claims the priority of Chinese Patent Application No. 201710648047.2, filed on Aug. 1, 2017, with the title of “Far field speech acoustic model training method and system”. The disclosure of the above applications is incorporated herein by reference in its entirety.

### FIELD OF THE DISCLOSURE

The present disclosure relates to the field of artificial intelligence, and particularly to a far field speech acoustic model training method and system.

### BACKGROUND OF THE DISCLOSURE

Artificial intelligence AI is a new technical science for researching and developing theories, methods, technologies and application systems for simulating, extending and expanding human intelligence. Artificial intelligence is a branch of computer sciences and attempts to learn about the essence of intelligence, and produces a type of new intelligent machines capable of responding in a manner similar to human intelligence. The studies in the field comprise robots, language recognition, image recognition, natural language processing, expert systems and the like.

As artificial intelligence develops constantly, speech interaction increasingly prevails as the most natural interaction manner. People have more and more demands for speech recognition service, and more and more smart products such as smart loudspeaker boxes, smart TV sets and smart refrigerators appear in the public consumables market. Appearance of this batch of smart devices gradually migrates speech recognition service from a near field to a far field. At present, near field speech recognition can already achieve a very high recognition rate. However, the recognition rate of far field speech recognition is by far lower than that of near field speech recognition due to influence of interfering factors such as noise and/or reverberation particularly when a speaker is 3-5 meters away from a microphone. The reason why the far field recognition performance falls so apparently is that under a far field scenario, amplitude of speech signals is too low, and other interfering factors such as noise and/or reverberation become prominent. An acoustic model in the current speech recognition system is usually generated by training with near field speech data, and mismatch of recognition data and training data causes rapid reduction of the far field speech recognition rate.

Therefore, a first problem which far field speech recognition algorithm research is faced with is how to obtain a lot of data. Now, far field data is obtained mainly by a method of recording data. To develop speech recognition service, it is usually necessary to spend a lot of time and manpower to record a lot of data in different rooms and different environments to ensure the performance of the algorithm. However, this needs to spend a lot of time costs and economic costs, and wastes a lot of near field training data.

### SUMMARY OF THE DISCLOSURE

A plurality of aspects of the present disclosure provide a far field speech acoustic model training method and system, to reduce time and economic costs of obtaining far field speech data, and improve the far field speech recognition effect.

According to an aspect of the present disclosure, there is provided a far field speech acoustic model training method, wherein the method comprises:

blending near field speech training data with far field speech training data to generate blended speech training data, wherein the far field speech training data is obtained by performing data augmentation processing for the near field speech training data;

using the blended speech training data to train a deep neural network to generate a far field recognition acoustic model.

The above aspect and any possible implementation mode further provide an implementation mode: the performing data augmentation processing for the near field speech training data comprises:

estimating an impulse response function under a far field environment;

using the impulse response function to perform filtration processing for the near field speech training data;

performing noise addition processing for data obtained after the filtration processing, to obtain far field speech training data.

The above aspect and any possible implementation mode further provide an implementation mode: the performing noise addition processing for data obtained after the filtration processing comprises:

selecting noise data;

using a signal-to-noise ratio SNR distribution function, to superimpose said noise data in the data obtained after the filtration processing.

The above aspect and any possible implementation mode further provide an implementation mode: the blending near field speech training data with far field speech training data to generate blended speech training data comprises:

segmenting the near field speech training data, to obtain N portions of near field speech training data, the N being a positive integer;

blending the far field speech training data with the N portions of near field speech training data respectively, to obtain N portions of blended speech training data, each portion of blended speech training data being used for one time of iteration during training of the deep neural network.

The above aspect and any possible implementation mode further provide an implementation mode: the using the blended speech training data to train a deep neural network to generate a far field recognition acoustic model comprises:

obtaining speech feature vectors by performing pre-processing and feature extraction for the blended speech training data;

training by taking the speech feature vectors as input of the deep neural network and speech identities in the speech training data as output of the deep neural network, to obtain the far field recognition acoustic model.

The above aspect and any possible implementation mode further provide an implementation mode: the method further comprises: training the deep neural network by adjusting parameters of the deep neural network through constant iteration, and blending, in each time of iteration, noise-added far field speech training data with segmented near field speech training data and scattering the blended data.

According to another aspect of the present disclosure, there is provided a far field speech acoustic model training system, wherein the system comprises: a blended speech training data generating unit configured to blend near field speech training data with far field speech training data to generate blended speech training data, wherein the far field speech training data is obtained by performing data augmentation processing for the near field speech training data;

a training unit configured to use the blended speech training data to train a deep neural network to generate a far field recognition acoustic model.

The above aspect and any possible implementation mode further provide an implementation mode: the system further comprises a data augmentation unit for performing data augmentation processing for the near field speech training data:

estimating an impulse response function under a far field environment;

using the impulse response function to perform filtration processing for the near field speech training data;

performing noise addition processing for data obtained after the filtration processing, to obtain far field speech training data.

The above aspect and any possible implementation mode further provide an implementation mode: upon estimating an impulse response function under a far field environment, the data augmentation unit specifically performs:

collecting multi-path impulse response functions under the far field environment;

merging the multi-path impulse response functions, to obtain the impulse response function under the far field environment.

The above aspect and any possible implementation mode further provide an implementation mode: upon performing noise addition processing for data obtained after the filtration processing, the data augmentation unit specifically performs: selecting noise data;

using a signal-to-noise ratio SNR distribution function, to superimpose said noise data in the data obtained after the filtration processing.

The above aspect and any possible implementation mode further provide an implementation mode: the blended speech training data generating unit is specifically configured to:

segment the near field speech training data, to obtain N portions of near field speech training data, the N being a positive integer;

blend the far field speech training data with the N portions of near field speech training data respectively, to obtain N portions of blended speech training data, each portion of blended speech training data being used for one time of iteration during training of the deep neural network.

The above aspect and any possible implementation mode further provide an implementation mode: the training unit is specifically configured to:

obtain speech feature vectors by performing pre-processing and feature extraction for the blended speech training data;

train by taking the speech feature vectors as input of the deep neural network and speech identities in the speech training data as output of the deep neural network, to obtain the far field recognition acoustic model.

The above aspect and any possible implementation mode further provide an implementation mode: the training subunit is specifically configured to: train the deep neural network by adjusting parameters of the deep neural network through constant iteration, and blending, in each time of iteration, noise-added far field speech training data with segmented near field speech training data and scattering the blended data.

According to a further aspect of the present disclosure, there is provided a device, wherein the device comprises:

one or more processors;

a storage for storing one or more programs, the one or more programs, when executed by said one or more processors, enable said one or more processors to implement the above-mentioned method.

According to another aspect of the present disclosure, there is provided a computer readable storage medium on which a computer program is stored, wherein the program, when executed by a processor, implements the above-mentioned method.

As known from the above technical solutions, the technical solutions of embodiments can be employed to avoid the problem of spending a lot of time costs and economic costs to obtain the far field speech data in the prior art; reduce time of obtaining the far field speech data, and reducing costs.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of a far field speech acoustic model training method according to an embodiment of the present disclosure;

FIG. 2 is a flow chart of performing data augmentation processing for near field speech training data in a far field speech acoustic model training method according to an embodiment of the present disclosure;

FIG. 3 is a flow chart of using near field speech training data to blend far field speech training data and generating blended speech training data in a far field speech acoustic model training method according to an embodiment of the present disclosure;

FIG. 4 is a flow chart of using the blended speech training data to train a deep neural network and generating a far field recognition acoustic model in a far field speech acoustic model training method according to an embodiment of the present disclosure;

FIG. 5 is a structural schematic diagram of a far field speech acoustic model training system according to another embodiment of the present disclosure;

FIG. 6 is a structural schematic diagram of a blended speech training data generating unit in a far field speech acoustic model training system according to another embodiment of the present disclosure;

FIG. 7 is a structural schematic diagram of a training unit in a far field speech acoustic model training system according to another embodiment of the present disclosure;

FIG. 8 is a block diagram of an example computer system/server 12 adapted to implement an embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

In addition, the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

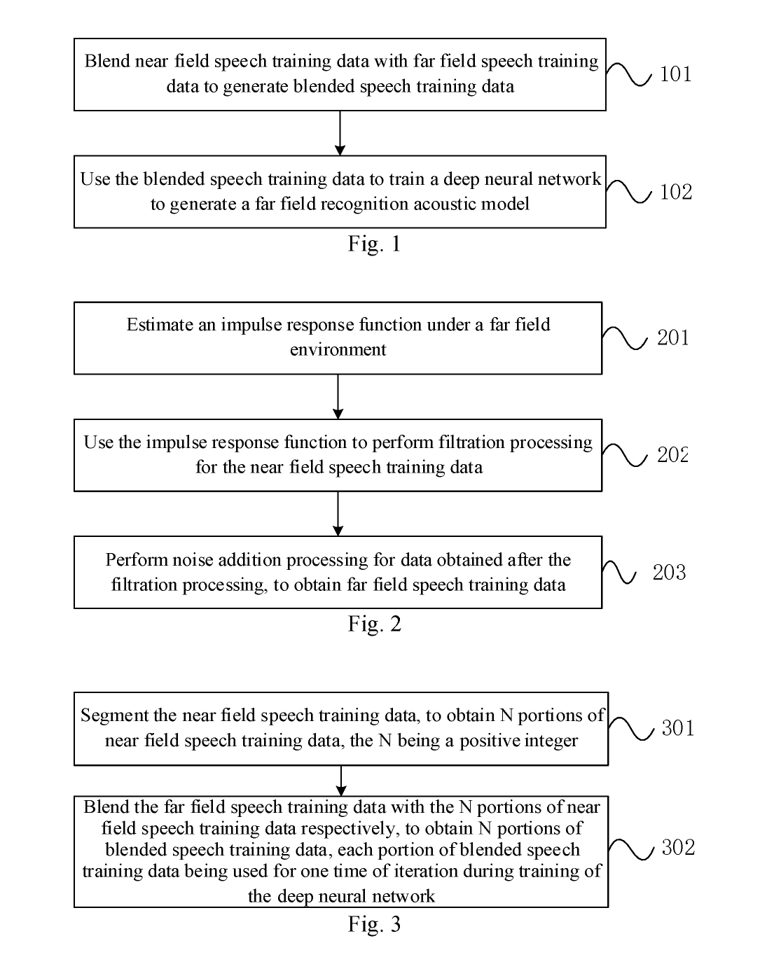

FIG. 1 is a flow chart of a far field speech acoustic model training method according to an embodiment of the present disclosure. As shown in FIG. 1, the method comprises the following steps:

101: blending near field speech training data with far field speech training data to generate blended speech training data, wherein the far field speech training data is obtained by performing data augmentation processing for the near field speech training data;

102: using the blended speech training data to train a deep neural network to generate a far field recognition acoustic model.

FIG. 2 is a flow chart of performing data augmentation processing for near field speech training data in a far field speech acoustic model training method according to an embodiment of the present disclosure. As shown in FIG. 2, the performing data augmentation processing for near field speech training data may comprise:

201: estimating an impulse response function under a far field environment;

202: using the impulse response function to perform filtration processing for the near field speech training data;

203: performing noise addition processing for data obtained after the filtration processing, to obtain far field speech training data.

In an implementation mode of the present embodiment, the estimating an impulse response function under a far field environment comprises:

collecting multi-path impulse response functions under the far field environment; merging the multi-path impulse response functions, to obtain the impulse response function under the far field environment.

For example, it is possible to use an independent high-fidelity loudspeaker box A (not a target test loudspeaker box) to broadcast a sweep signal that gradually changes from 0 to 16000 Hz, as a far field sound source, and then use a target test loudspeaker box B at a different location to collect record of the sweep signal, and then obtain the multi-path impulse response functions through a digital signal processing theory. The multi-path impulse response functions can simulate a final result of the sound source that is subjected to impacts such as spatial transmission and/or room reflection and reaches the target test loudspeaker box B.

In an implementation mode of the present embodiment, the number of the far field sound source and target test loudspeaker boxes B at different locations in combination is not less than 50; the multi-path impulse response functions are merged, for example, weighted average processing, to obtain the impulse response function under the far field environment; the impulse response function under the far field environment can simulate a reverberation effect of the far field environment.

In an implementation mode of the present embodiment, the using the impulse response function to perform filtration processing for the near field speech training data comprises:

performing a time-domain convolution operation or frequency-domain multiplication operation for the impulse response function and the near field speech training data.

Since the near field speech recognition is used very widely, and a lot near field speech training data are already accumulated, already-existing near field speech training data may be used. It needs to be noted that the near field speech training data may include speech identity, the speech identity may be used to distinguish basis speech elements, and the speech identity may take many forms, for example, letter, number, symbol, character and so on.

The near field speech training data is pure data, namely, speech recognition training data collected in a quiet environment.

Optionally, it is possible to use all already-existing near field speech training data, or screen all already-existing near field speech training data to select partial near field speech training data. A specific screening criterion may be preset, e.g., randomly select or select in an optimized manner satisfying a preset criterion. It is possible to, by selecting all already-existing data or selecting partial data, select a data scale according to actual demands, to meet different actual demands.

It is feasible to use the merged impulse response function as a filter function, use the impulse response function under the far field environment to perform a filtration operation for the near field speech training data, for example a time-domain convolution operation or frequency-domain multiplication operation, to simulate the influence of the far field environment on the reverberation effect.

Speech collected from a real far field contains a lot of noise. Hence, to better simulate the far field speech training data, it is necessary to perform noise addition processing for the data obtained after the filtration processing.

The performing noise addition processing for data obtained after the filtration processing, to obtain far field speech training data may comprise: selecting noise data;

using a signal-to-noise ratio SNR distribution function, to superimpose said noise data in the data obtained after the filtration processing.

For example, the type of the noise data needs to be integrated with a specific product application scenario. Most loudspeaker box products are used indoor. Noise mainly comes from appliances such as TV set, refrigerator, exhaust hood, air conditioner and washing machine. It is necessary to collect the noise in advance and perform joining processing, to obtain a pure noise segment.

A lot of noise data under a noise environment in an actual application scenario is collected. The noise data do not contain speech segments, namely, contains non-speech segments; or non-speech segments are cut out from the noise data.

It is feasible to pre-screen all non-speech paragraphs to select stable non-speech paragraphs whose duration exceeds a predetermined threshold.

The selected non-speech segments are joined as a pure noise segment.

It is feasible to randomly cut out, from the pure noise segment, a noise fragment which is equal to a time length for simulating pure far field speech training data.

It is feasible to create a signal-to-noise ratio SNR distribution function of the noise; for example, employ a distribution function similar to Rayleigh Distribution:

$$f ( x ; μ , σ ) = \frac{x - μ}{{σ}^{2}} exp ( - \frac{{( x - μ )}^{2}}{2 {σ}^{2}} ) .$$

A probability density curve that better meets an expectation is obtained by adjusting an expectation μ and a standard deviation σ; the probability density curve is then discretized, for example, a SNR change granularity is 1 dB, and then it is necessary to perform integration for the probability density curve in each 1 dB, to obtain a probability of each 1 dB.

It is feasible to perform signal superimposition for the cut-out noise fragment and the data obtained after the filtration processing according to the signal-to-noise ratio SNR, to obtain the far field speech training data.

The far field speech training data obtained through the above steps simulates the far field reverberation effect through the introduction of the impulse response function, and simulates an actual noise environment through the introduction of the noise addition processing. The two points are right two most important differences between the far field recognition and near field recognition.

However, the distribution of the far field speech training data obtained through the above steps deviates from the actually-recorded far field speech training data. It is necessary to perform certain regularization to prevent the model from excessively fitting with simulated data. A most effective method of prevent excessive fitting is increasing a training set. The larger the training set is, the smaller the fitting probability is.

FIG. 3 is a flow chart of blending near field speech training data with far field speech training data and generating blended speech training data in a far field speech acoustic model training method according to the present disclosure. As shown in FIG. 3, the blending near field speech training data with far field speech training data and generating blended speech training data may comprise:

301: segmenting the near field speech training data, to obtain N portions of near field speech training data, the N being a positive integer.

It is feasible to determine a blending proportion of noised-added far field speech training data and near field speech training data, namely, determine the amount of near field speech training data needed by each time of iteration during the training of the far field recognition acoustic model; for example, during training, if each time of iteration uses a total amount of noise-added far field speech training data N1 items, and a proportion of the noise-added far field speech training data to the near field speech training data is 1:a, each time of iteration needs near field speech training data N2=a*N1 items. There are totally M items of near field speech training data. It is possible to segment the near field speech training data as N=floor (M/N2) blocks, wherein floor ( ) is an operator for taking an integer downwardly.

302: blending the far field speech training data with the N portions of near field speech training data respectively, to obtain N portions of blended speech training data, each portion of blended speech training data being used to one time of iteration during training of the deep neural network.

In each time of iteration, it is necessary to blend the total amount of noise-added far field speech training data with the near field speech training data with the determined blending proportion, and sufficiently scatter the blended data. For example, in each time of iteration, it is feasible to blend all N1 items of noise-added far field speech training data with the (i % N)^{th} portion of, namely, the (i % N)^{th} N2 items of near field speech training data, and scatter the blended data, wherein i represents iteration times of the training, and % represents a remainder-obtaining operation.

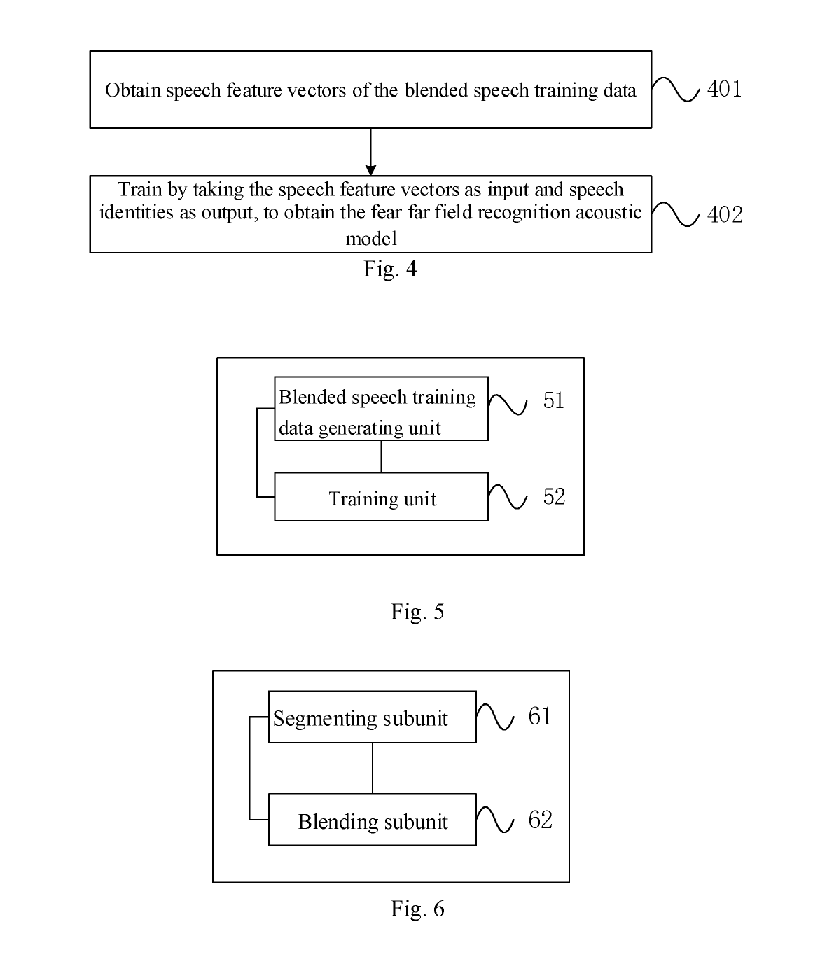

FIG. 4 is a flow chart of using the blended speech training data to train a deep neural network and generating a far field recognition acoustic model in a far field speech acoustic model training method according to the present disclosure. As shown in FIG. 4, the using the blended speech training data to train a deep neural network and generating a far field recognition acoustic model may comprise:

401: obtaining speech feature vectors of the blended speech training data;

The speech feature vectors are a data set which is obtained after performing pre-processing and feature extraction for the blended speech training data and includes speech features. The pre-processing for the blended speech training data includes performing sampling quantization, pre-emphasis, windowing and framing, and endpoint detection for the blended speech training data. After the pre-processing, a high-frequency resolution of the blended speech training data is improved, the blended speech training data become smoother, and subsequent processing of the blended speech training data is facilitated.

Various acoustic feature extraction methods are used to extract feature vectors from the blended speech training data.

In some optional implementation modes of the present embodiment, the feature vectors may be extracted from the abovementioned target speech signals based on Mel-Frequency Cepstral Coefficients. Specifically, it is feasible to first use a fast algorithm of discrete Fourier transform to perform time domain-to-frequency domain transformation for the target speech signals, to obtain an energy frequency; then, perform convolution computation for the energy spectrum of the target speech signals by using a triangular bandpass filter method and according to Mel scale distribution, to obtain a plurality of output logarithm energies, and finally perform discrete cosine transform for vectors comprised of the plurality of output logarithm energies, to generate feature vectors.

In some optional implementation modes of the present embodiment, it is further possible to generate parameter of a vocal tract excitation and transfer function by using a linear predictive coding method and by parsing the target speech signals, and generate the feature vectors by regarding the generated parameters as feature parameters.

402: training by taking the speech feature vectors as input and the speech identity as output, to obtain the far field recognition acoustic model.

The speech feature vectors are input from an input layer of the deep neural network to obtain an output probability of the deep neural network, and parameters of the deep neural network are adjusted according to an error between the output probability and a desired output probability.

The deep neural network comprises an input layer, a plurality of hidden layers, and an output layer. The input layer is used to calculate an output value input to a hidden layer unit of a bottommost layer according to the speech feature vectors input to the deep neural network. The hidden layer is used to, according to a weighted value of the present layer, perform weighted summation for an input value coming from next layer of hidden layer, and calculate an output value output to a preceding layer of hidden layer. The output layer is used to, according to the weighted value of the present layer, perform weighted summation for an output value coming from a hidden layer unit of a topmost layer of hidden layer, and calculate an output probability according to a result of the weighted summation. The output probability is output by the output unit, and represents a probability that the input speech feature vectors are the speech identities corresponding to the output unit.

The input layer comprises a plurality of input units. The input units are used to calculate an output value output to the bottommost hidden layer according to input speech feature vectors. After the speech feature vectors are input to the input unit, the input unit calculates the output value output to the bottommost hidden layer by using the speech feature vectors input to the input unit according to its own weighted value.

Each of the plurality of hidden layers comprises a plurality of hidden layer units. The hidden layer unit receives an input value coming from the hidden layer unit of next layer of hidden layer, and according to a weighted value of the present layer, performs weighted summation for an input value coming from the hidden layer unit of next layer of hidden layer, and regards a weighted summation result as an output value output to the hidden layer unit of a preceding layer of hidden layer.

The output layer comprises a plurality of output units. The number of output units of each output layer is equal to the number of speech identities included by the speech. The output unit receives an input value from the hidden layer unit of the topmost layer of hidden layer, and according to the weighted value of the present layer, performs weighted summation for an input value coming from the hidden layer unit of the topmost layer of hidden layer, and calculates an output probability by using a softmax function according to a result of the weighted summation. The output probability represents a probability that the speech feature vectors input to the acoustic model belong to the speech identities corresponding to the output unit.

After which speech identities the speech feature vectors are is judged according to the output probability of the different output units, text data corresponding to the speech feature vectors may be output through the processing of other additional modules.

After the structure of the far field recognition acoustic model, namely, the structure of the deep neural network, is determined, it is necessary to determine parameters of the deep neural network, namely, weighted values of respective layers; the weighted values comprise a weight value of the input layer, a weighted value of the plurality of hidden layers, and a weighted value of the output layer. That is to say, the deep neural network needs to be trained. An error between the output probability and a desired output probability is calculated, and the parameters of the deep neural network are adjusted according to the error between the output probability of the deep neural network and the desired output probability.

The parameter adjustment procedure is implemented through constant iteration. During iteration, it is possible to constantly modify parameter setting of a parameter updating policy and judge convergence of the iteration, and stop the iteration procedure when the iteration converges. Each portion of blended speech training data in N portions of blended speech training data is respectively used for one time of iteration during the training of the deep neural network.

In an optional implementation mode of the present embodiment, a steepest descent algorithm is employed as an algorithm of using the error between the output probability and the desired output probability to adjust the weighted value of the deep neural network.

After generating the far field recognition acoustic model, the method may further comprise the following steps: performing far field recognition according to the far field recognition acoustic model.

According to the far field speech acoustic model training method according to the present embodiment, the already-existing near field speech training data is used as a data source to generate far field speech training data, and the acoustic model can be prevented from excessively fitting with simulated far field training data through regularization processing for the far field speech training data; this saves a lot of sound recording costs and substantially improves the far field recognition effect. This method may be used in any far field recognition task, and substantially improves the far field recognition performance.

It needs to be appreciated that regarding the aforesaid method embodiments, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 5 is a structural schematic diagram of a far field speech acoustic model training system according to another embodiment of the present disclosure. As shown in FIG. 5, the system comprises:

a blended speech training data generating unit 51 configured to blend near field speech training data with far field speech training data to generate blended speech training data, wherein the far field speech training data is obtained by performing data augmentation processing for the near field speech training data;

a training unit 52 configured to use the blended speech training data to train a deep neural network to generate a far field recognition acoustic model.

The system further comprises a data augmentation unit for performing data augmentation processing for near field speech training data:

estimating an impulse response function under a far field environment;

using the impulse response function to perform filtration processing for the near field speech training data;

performing noise addition processing for data obtained after the filtration processing, to obtain far field speech training data.

Upon estimating an impulse response function under a far field environment, the data augmentation unit specifically performs:

collecting multi-path impulse response functions under the far field environment;

merging the multi-path impulse response functions, to obtain the impulse response function under the far field environment.

Upon performing noise addition processing for data obtained after the filtration processing, the data augmentation unit specifically performs:

selecting noise data;

using a signal-to-noise ratio SNR distribution function, to superimpose said noise data in the data obtained after the filtration processing.

Those skilled in the art can clearly understand that for purpose of convenience and brevity of depictions, reference may be made to corresponding procedures in the aforesaid method embodiments for a specific workflow of the data augmentation unit performing data augmentation processing for the near field speech training data, which will not be detailed any more.

The distribution of the far field speech training data obtained by performing data augmentation processing for the near field speech training data deviates from the actually-recorded far field speech training data. It is necessary to perform certain regularization to prevent the model from excessively fitting with simulated data. A most effective method of prevent excessive fitting is increasing a training set. The larger the training set is, the smaller the fitting probability is.

FIG. 6 is a structural schematic diagram of the blended speech training data generating unit 51 in the far field speech acoustic model training system according to the present disclosure. As shown in FIG. 6, the blended speech training data generating unit 51 may comprise:

a segmenting subunit 61 configured to segment the near field speech training data, to obtain N portions of near field speech training data, the N being a positive integer.

It is feasible to determine a blending proportion of noised-added far field speech training data and near field speech training data, namely, determine the amount of near field speech training data needed by each time of iteration during the training of the far field recognition acoustic model; for example, during training, if each time of iteration uses a total amount of noise-added far field speech training data N1 items, and a proportion of the noise-added far field speech training data to the near field speech training data is 1:a, each time of iteration needs near field speech training data N2=a*N1 items. There are totally M items of near field speech training data. It is possible to segment the near field speech training data as N=floor (M/N2) blocks, wherein floor ( ) is an operator for taking an integer downwardly.

a blending subunit 62 configured to blend the far field speech training data with the N portions of near field speech training data respectively, to obtain N portions of blended speech training data, each portion of blended speech training data being used for one time of iteration during training of the deep neural network.

In each time of iteration, it is necessary to blend the total amount of noise-added far field speech training data with the near field speech training data with the determined blending proportion, and sufficiently scatter the blended data. For example, in each time of iteration, it is feasible to blend all N1 items of noise-added far field speech training data with the (i % N)^{th} portion of, namely, the (i % N)^{th} N2 items of near field speech training data, and scatter the blended data, wherein i represents iteration times of the training, and % represents a remainder-obtaining operation.

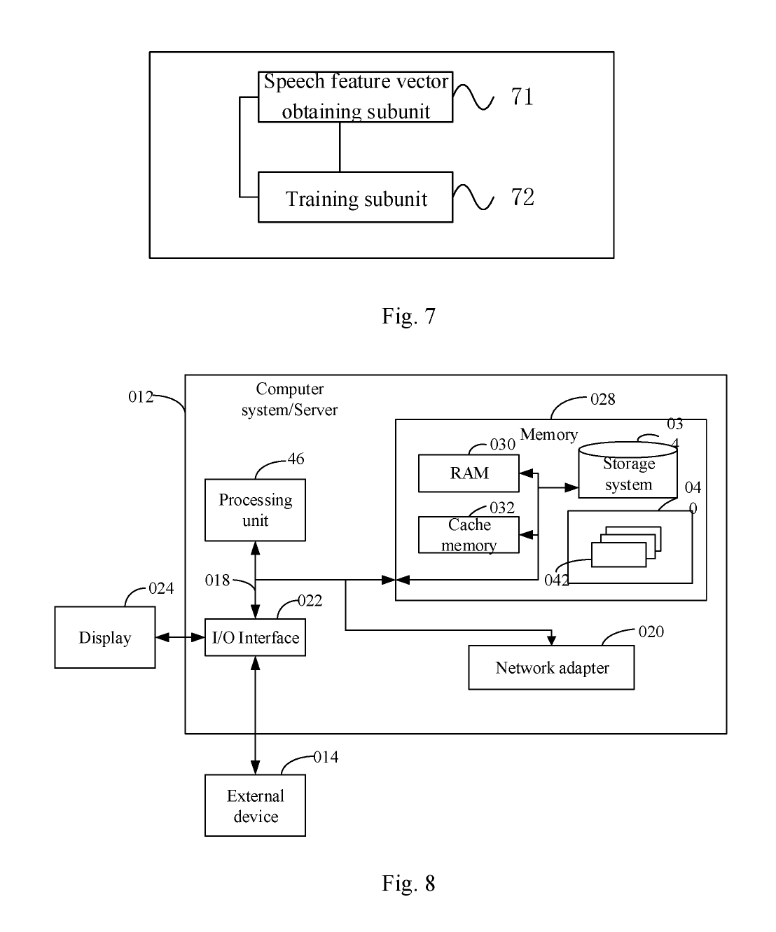

FIG. 7 is a structural schematic diagram of the training unit 52 in the far field speech acoustic model training system according to the present disclosure. As shown in FIG. 7, the training unit 52 may comprise:

a speech feature vector obtaining subunit 71 configured to obtain speech feature vectors of the blended speech training data;

The speech feature vectors are a data set which is obtained after performing pre-processing and feature extraction for the blended speech training data and includes speech features.

For example, the pre-processing for the blended speech training data includes performing sampling quantization, pre-emphasis, windowing and framing, and endpoint detection for the blended speech training data. After the pre-processing, a high-frequency resolution of the blended speech training data is improved, the blended speech training data become smoother, and subsequent processing of the blended speech training data is facilitated.

Various acoustic feature extraction methods are used to extract feature vectors from the blended speech training data.

In some optional implementation modes of the present embodiment, the feature vectors may be extracted from the abovementioned target speech signals based on Mel-Frequency Cepstral Coefficients. Specifically, it is feasible to first use a fast algorithm of discrete Fourier transform to perform time domain-to-frequency domain transformation for the target speech signals, to obtain an energy frequency; then, perform convolution computation for the energy spectrum of the target speech signals by using a triangular bandpass filter method and according to Mel scale distribution, to obtain a plurality of output logarithm energies, and finally perform discrete cosine transform for vectors comprised of the plurality of output logarithm energies, to generate feature vectors.

In some optional implementation modes of the present embodiment, it is further possible to generate parameter of a vocal tract excitation and transfer function by using a linear predictive coding method and by parsing the target speech signals, and generate the feature vectors by regarding the generated parameters as feature parameters.

a training subunit 72 configured to train by taking the speech feature vectors as input and the speech identity as output, to obtain the far field recognition acoustic model.

The speech feature vectors are input from an input layer of the deep neural network to obtain an output probability of the deep neural network, and parameters of the deep neural network are adjusted according to an error between the output probability and a desired output probability.

The deep neural network comprises an input layer, a plurality of hidden layers, and an output layer. The input layer is used to calculate an output value input to the bottommost layer of hidden layer unit according to the speech feature vectors input to the deep neural network. The hidden layer is used to, according to a weighted value of the present layer, perform weighted summation for an input value coming from next layer of hidden layer, and calculate an output value output to a preceding layer of hidden layer. The output layer is used to, according to the weighted value of the present layer, perform weighted summation for an output value coming from the topmost layer of hidden layer unit, and calculate an output probability according to a result of the weighted summation. The output probability is output by the output unit, and represents a probability that the input speech feature vectors are the speech identities corresponding to the output unit.

The input layer comprises a plurality of input units. The input units are used to calculate an output value output to the bottommost hidden layer according to input speech feature vectors. After the speech feature vectors are input to the input unit, the input unit calculates the output value output to the bottommost hidden layer by using the speech feature vectors input to the input unit according to its own weighted value.

Each of the plurality of hidden layers comprises a plurality of hidden layer units. The hidden layer unit receives an input value coming from the hidden layer unit of next layer of hidden layer, and according to the weighted value of the present layer, performs weighted summation for an input value coming from the hidden layer unit of next layer of hidden layer, and regards a weighted summation result as an output value output to the hidden layer unit of a preceding layer of hidden layer.

The output layer comprises a plurality of output units. The number of output units of each output layer is equal to the number of speech identities included by the speech. The output unit receives an input value from the hidden layer unit of the topmost layer of hidden layer, and according to the weighted value of the present layer, performs weighted summation for an input value coming from the hidden layer unit of the topmost layer of hidden layer, and calculates an output probability by using a softmax function according to a result of the weighted summation. The output probability represents a probability that the speech feature vectors input to the acoustic model belong to the speech identities corresponding to the output unit.

After which speech identities the speech feature vectors are is judged according to the output probability of the different output units, text data corresponding to the speech feature vectors may be output through the processing of other additional modules.

After the structure of the far field recognition acoustic model, namely, the structure of the deep neural network, is determined, it is necessary to determine parameters of the deep neural network, namely, weighted values of respective layers; the weighted values comprise a weight value of the input layer, a weighted value of the plurality of hidden layers, and a weighted value of the output layer. That is to say, the deep neural network needs to be trained.

When the blended speech training data are used to train the deep neural network, the blended speech training data are input from the input layer of the deep neural network to the deep neural network, to obtain the output probability of the deep neural network. An error between the output probability and a desired output probability is calculated, and the parameters of the deep neural network are adjusted according to the error between the output probability of the deep neural network and the desired output probability.

The parameter adjustment procedure is implemented through constant iteration. During iteration, it is possible to constantly modify parameter setting of a parameter updating policy and judge convergence of the iteration, and stop the iteration procedure when the iteration converges. Each portion of blended speech training data in N portions of blended speech training data is respectively used for one time of iteration during the training of the deep neural network.

The far field speech acoustic model training system may further comprise the following unit: a recognition unit configured to perform far field recognition according to the far field recognition acoustic model.

According to the far field speech acoustic model training system according to the present embodiment, the already-existing near field speech training data is used as a data source to generate simulated far field speech training data, and the acoustic model can be prevented from excessively fitting with the simulated far field training data through regularization processing for the simulated far field speech training data; this saves a lot of sound recording costs and substantially improves the far field recognition effect. Experiments prove that the system may be used in any far field recognition task, and substantially improves the far field recognition performance.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed method and apparatus can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

FIG. 8 illustrates a block diagram of an example computer system/server 012 adapted to implement an implementation mode of the present disclosure. The computer system/server 012 shown in FIG. 8 is only an example and should not bring about any limitation to the function and scope of use of the embodiments of the present disclosure.

As shown in FIG. 8, the computer system/server 012 is shown in the form of a general-purpose computing device. The components of computer system/server 012 may include, but are not limited to, one or more processors (processing units) 016, a memory 028, and a bus 018 that couples various system components including system memory 028 and the processor 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

Memory 028 can include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 can be provided for reading from and writing to a non-removable, non-volatile magnetic media (not shown in FIG. 8 and typically called a “hard drive”). Although not shown in FIG. 8, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 018 by one or more data media interfaces. The memory 028 may include at least one program product having a set (e.g., at least one) of program modules that are configured to carry out the functions of embodiments of the present disclosure.

Program/utility 040, having a set (at least one) of program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc. In the present disclosure, the computer system/server 012 communicates with an external radar device, or with one or more devices that enable a user to interact with computer system/server 012; and/or with any devices (e.g., network card, modem, etc.) that enable computer system/server 012 to communicate with one or more other computing devices. Such communication can occur via Input/Output (I/O) interfaces 022. Still yet, computer system/server 012 can communicate with one or more networks such as a local area network (LAN), a general wide area network (WAN), and/or a public network (e.g., the Internet) via a network adapter 020. As depicted in the figure, network adapter 020 communicates with the other communication modules of computer system/server 012 via the bus 018. It should be understood that although not shown, other hardware and/or software modules could be used in conjunction with computer system/server 012. Examples, include, but are not limited to: microcode, device drivers, redundant processing units, external disk drive arrays, RAID systems, tape drives, and data archival storage systems, etc.

The processing unit 016 executes functions and/or methods in embodiments described in the present disclosure by running programs stored in the memory 028.

The above-mentioned computer program may be set in a computer storage medium, i.e., the computer storage medium is encoded with a computer program. When the program, executed by one or more computers, enables said one or more computers to execute steps of methods and/or operations of apparatuses as shown in the above embodiments of the present disclosure.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a computer readable signal medium or a computer readable storage medium. A computer readable medium for example may include, but not limited to, an electronic, magnetic, optical, electromagnetic, infrared, or semiconductor system, apparatus, or device, or any suitable combination of the foregoing. More specific examples (non-exhaustive listing) of the computer readable storage medium would include an electrical connection having one or more conductor wires, a portable computer magnetic disk, a hard disk, a random access memory (RAM), a read-only memory (ROM), an erasable programmable read-only memory (EPROM or Flash memory), optical fiber, a portable compact disc read-only memory (CD-ROM), an optical storage device, a magnetic storage device, or any suitable combination of the foregoing. In the text herein, the computer readable storage medium can be any tangible medium that includes or stores a program. The program may be used by an instruction execution system, apparatus or device or used in conjunction therewith.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not cause essence of corresponding technical solutions to depart from the spirit and scope of technical solutions of embodiments of the present disclosure.

What is claimed is:

1. A far field speech acoustic model training method, wherein the method comprises:
blending near field speech training data with far field speech training data to generate blended speech training data, wherein the far field speech training data is obtained by performing data augmentation processing for the near field speech training data;
using the blended speech training data to train a deep neural network to generate a far field recognition acoustic model.

2. The method according to claim 1, wherein the performing data augmentation processing for the near field speech training data comprises:
estimating an impulse response function under a far field environment;
using the impulse response function to perform filtration processing for the near field speech training data;
performing noise addition processing for data obtained after the filtration processing, to obtain far field speech training data.

3. The method according to claim 2, wherein the estimating an impulse response function under a far field environment comprises:
collecting multi-path impulse response functions under the far field environment;
merging the multi-path impulse response functions, to obtain the impulse response function under the far field environment.

4. The method according to claim 2, wherein the performing noise addition processing for data obtained after the filtration processing comprises:
selecting noise data;
using a signal-to-noise ratio SNR distribution function, to superimpose said noise data in the data obtained after the filtration processing.

5. The method according to claim 1, wherein the blending near field speech training data with far field speech training data to generate blended speech training data comprises:
segmenting the near field speech training data, to obtain N portions of near field speech training data, the N being a positive integer;
blending the far field speech training data with the N portions of near field speech training data respectively, to obtain N portions of blended speech training data, each portion of blended speech training data being used for one time of iteration during training of the deep neural network.

6. The method according to claim 1, wherein the using the blended speech training data to train a deep neural network to generate a far field recognition acoustic model comprises:
obtaining speech feature vectors by performing pre-processing and feature extraction for the blended speech training data;
training by taking the speech feature vectors as input of the deep neural network and speech identities in the speech training data as output of the deep neural network, to obtain the far field recognition acoustic model.

7. A device, wherein the device comprises:
one or more processors;
a memory for storing one or more programs,
the one or more programs, when executed by said one or more processors, enable said one or more processors to implement a far field speech acoustic model training method, wherein the method comprises:
blending near field speech training data with far field speech training data to generate blended speech training data, wherein the far field speech training data is obtained by performing data augmentation processing for the near field speech training data;
using the blended speech training data to train a deep neural network to generate a far field recognition acoustic model.

8. The device according to claim 7, wherein the performing data augmentation processing for the near field speech training data comprises:
estimating an impulse response function under a far field environment;
using the impulse response function to perform filtration processing for the near field speech training data;
performing noise addition processing for data obtained after the filtration processing, to obtain far field speech training data.

9. The device according to claim 8, wherein the estimating an impulse response function under a far field environment comprises:
collecting multi-path impulse response functions under the far field environment;
merging the multi-path impulse response functions, to obtain the impulse response function under the far field environment.

10. The device according to claim 8, wherein the performing noise addition processing for data obtained after the filtration processing comprises:
selecting noise data;
using a signal-to-noise ratio SNR distribution function, to superimpose said noise data in the data obtained after the filtration processing.

11. The device according to claim 7, wherein the blending near field speech training data with far field speech training data to generate blended speech training data comprises:
segmenting the near field speech training data, to obtain N portions of near field speech training data, the N being a positive integer;
blending the far field speech training data with the N portions of near field speech training data respectively, to obtain N portions of blended speech training data, each portion of blended speech training data being used for one time of iteration during training of the deep neural network.

12. The device according to claim 7, wherein the using the blended speech training data to train a deep neural network to generate a far field recognition acoustic model comprises:
obtaining speech feature vectors by performing pre-processing and feature extraction for the blended speech training data;
training by taking the speech feature vectors as input of the deep neural network and speech identities in the speech training data as output of the deep neural network, to obtain the far field recognition acoustic model.

13. A computer readable storage medium on which a computer program is stored, wherein the program, when executed by a processor, implements a far field speech acoustic model training method, wherein the method comprises:
blending near field speech training data with far field speech training data to generate blended speech training data, wherein the far field speech training data is obtained by performing data augmentation processing for the near field speech training data;
using the blended speech training data to train a deep neural network to generate a far field recognition acoustic model.

14. The computer readable storage medium according to claim 13, wherein the performing data augmentation processing for the near field speech training data comprises:
estimating an impulse response function under a far field environment;
using the impulse response function to perform filtration processing for the near field speech training data;
performing noise addition processing for data obtained after the filtration processing, to obtain far field speech training data.

15. The computer readable storage medium according to claim 14, wherein the estimating an impulse response function under a far field environment comprises:
collecting multi-path impulse response functions under the far field environment;
merging the multi-path impulse response functions, to obtain the impulse response function under the far field environment.

16. The computer readable storage medium according to claim 14, wherein the performing noise addition processing for data obtained after the filtration processing comprises:
selecting noise data;
using a signal-to-noise ratio SNR distribution function, to superimpose said noise data in the data obtained after the filtration processing.

17. The computer readable storage medium according to claim 13, wherein the blending near field speech training data with far field speech training data to generate blended speech training data comprises:
segmenting the near field speech training data, to obtain N portions of near field speech training data, the N being a positive integer;
blending the far field speech training data with the N portions of near field speech training data respectively, to obtain N portions of blended speech training data, each portion of blended speech training data being used for one time of iteration during training of the deep neural network.

18. The computer readable storage medium according to claim 13, wherein the using the blended speech training data to train a deep neural network to generate a far field recognition acoustic model comprises:
obtaining speech feature vectors by performing pre-processing and feature extraction for the blended speech training data;
training by taking the speech feature vectors as input of the deep neural network and speech identities in the speech training data as output of the deep neural network, to obtain the far field recognition acoustic model.
